(19) United States
(12) Patent Application Publication
(10) Pub. No.: US 2017/0282845 A1
(43) Pub. Date: Oct. 5, 2017

(54) CYCLIST PROTECTION APPARATUS FOR VEHICLE AND VEHICLE

(71) Applicant: Fuji Jukogyo Kabushiki Kaisha, Tokyo (JP)

(72) Inventors: Isamu NAGASAWA, Tokyo (JP); Takao KONDO, Tokyo (JP)

(21) Appl. No.: 15/435,114

(22) Filed: Feb. 16, 2017

(30) Foreign Application Priority Data
Mar. 31, 2016 (JP) 2016-071693

(51) Int. Cl. B60R 21/36; B60R 11/04; B60R 21/0134; B60R 21/38

(52) U.S. Cl. CPC B60R 21/36; B60R 21/38; B60R 11/04; B60R 21/0134; B60R 2021/0004

(57) ABSTRACT

A cyclist protection apparatus for a vehicle includes including a front section that protrudes forward from a boarding section and includes an upper surface formed by a hood. The cyclist protection apparatus includes a hood latch and a cyclist airbag device. The hood latch is capable of releasing a closed state of the hood such that a front of the hood is openable. The cyclist airbag device is configured to be disposed in the front section below the hood and deploy a cyclist airbag. The cyclist airbag device is configured to deploy the cyclist airbag forward from below the hood in either one of a state where the front of the hood is open and a state where the front of the hood is openable.

### CROSS-REFERENCE TO RELATED APPLICATIONS

The present application claims priority from Japanese Patent Application No. 2016-071693 filed on Mar. 31, 2016, the entire contents of which are hereby incorporated by reference.

### BACKGROUND

### 1. Technical Field

The present invention relates to cyclist protection apparatuses for vehicles and vehicles.

### 2. Related Art

Vehicles, such as automobiles, have the possibility of colliding with pedestrians moving outside the vehicles.

In Japanese Unexamined Patent Application Publication (JP-A) Nos. 2010-012966 and 09-030368, a plurality of airbags are deployed in a flatly-arranged manner on the hood.

Thus, the airbags are deployed flat between the upper body of a pedestrian colliding with the front of the vehicle and the hood, thereby attenuating the impact.

Moreover, vehicles, such as automobiles, also have the possibility of colliding with, for example, cyclists riding on bicycles, in addition to pedestrians.

If a cyclist and an automobile collide with each other, there is a possibility that the protection apparatus according to JP-A Nos. 2010-012966 and 09-030368 cannot properly protect the cyclist due to the position of the cyclist's waist being high.

After the collision, the cyclist may fall up onto the hood of the automobile, have his/her waist caught on the hood, and then bounce up from the dented hood. In this type of collision, there is a possibility that the protection apparatus according to JP-A Nos. 2010-012966 and 09-030368 cannot sufficiently exhibit its function.

### SUMMARY OF THE INVENTION

Accordingly, in a vehicle, it is desirable to enhance the performance for protecting a colliding cyclist.

An aspect of the present invention provides a cyclist protection apparatus for a vehicle including a front section that protrudes forward from a boarding section. The front section includes an upper surface formed by a hood. The cyclist protection apparatus includes a hood latch capable of releasing a closed state of the hood such that a front of the hood is openable, and a cyclist airbag device configured to be disposed in the front section below the hood and that deploys a cyclist airbag. The cyclist airbag device is configured to deploy the cyclist airbag forward from below the hood in either one of a state where the front of the hood is open and a state where the front of the hood is openable.

The cyclist protection apparatus may further include an actuator configured to drive the hood so as to open the front of the hood.

The cyclist airbag may be configured to start to deploy forward from below the hood and subsequently deploy upward.

The cyclist airbag may be configured to deploy to a height equal to or above a height of a cyclist's shoulder.

The cyclist protection apparatus may further include a nose cone to be provided in front of the hood in the front section. A rear-end area of an upper surface of the nose cone may have a forward-rising slope. The cyclist airbag, which has started to deploy forward from below the hood, may deploy upward by abutting on the slope.

The cyclist airbag may include a tether that couples a center of an upper surface to a lower surface of a leading end of the cyclist airbag. Moreover, the cyclist airbag may be configured to start to deploy forward from below the hood and may subsequently deploy upward by being pulled upward by tension of the tether.

The cyclist protection apparatus may further include a nose cone to be provided in front of the hood in the front section. A rear-end area of an upper surface of the nose cone may be provided with a movable piece that is vertically rotatable. The cyclist airbag, which has started to deploy forward from below the hood, may deploy upward by abutting on the movable piece as the cyclist airbag deploys forward from below the hood.

Another aspect of the present invention provides a vehicle. The vehicle include a hood, a front section, a hood latch and a cyclist airbag device. The front section protrudes forward from a boarding section and has an upper surface formed by the hood. The hood latch is capable of releasing a closed state of the hood such that a front of the hood is openable. The cyclist airbag device is configured to be disposed in the front section below the hood and configured to deploy a cyclist airbag. The cyclist airbag device is configured to deploy the cyclist airbag forward from below the hood in either one of a state where the front of the hood is open and a state where the front of the hood is openable.

### BRIEF DESCRIPTION OF THE DRAWINGS

FIG. 1 is a perspective side view of an automobile according to an implementation of the present invention;

FIGS. 2A to 2D illustrate an example of a vehicle-to-cyclist collision mode;

FIG. 3 illustrates an example of a vehicle-to-pedestrian collision mode;

FIGS. 4A and 4B illustrate a cyclist protection apparatus according to this implementation;

FIGS. 5A to 5C illustrate configuration examples in which the deployment direction of a cyclist airbag is converted from the forward direction to the upward direction;

FIG. 6 is a block diagram of a control system of the cyclist protection apparatus in FIGS. 4A and 4B;

FIG. 7 is a flowchart of control executed by a controller in FIG. 6 when a collision with a cyclist occurs; and

FIGS. 8A to 8C illustrate an example of a vehicle-to-cyclist collision mode according to this implementation.

### DETAILED DESCRIPTION

An implementation of the present invention will be described below with reference to the appended drawings.

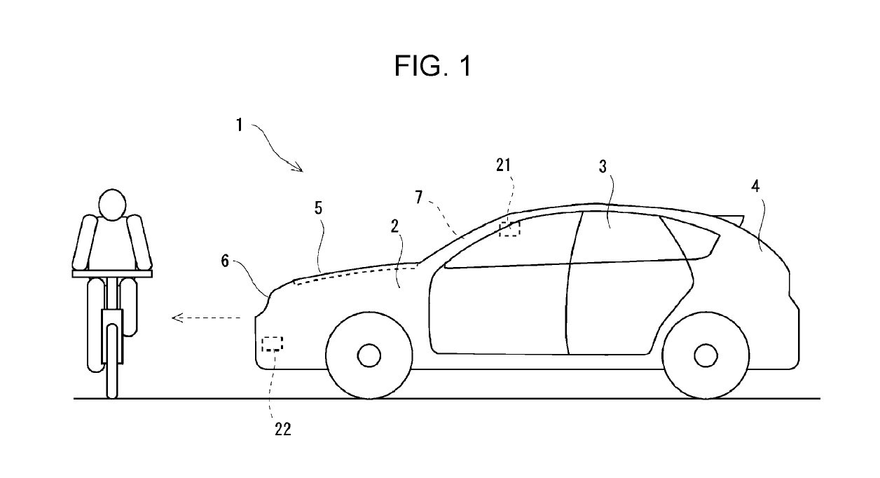

FIG. 1 is a perspective side view of an automobile 1 according to an implementation of the present invention. In FIG. 1, a side surface of the automobile 1 is illustrated together with a cyclist cycling across in front of the automobile 1.

The automobile 1 is an example of a vehicle. A vehicle body of the automobile 1 in FIG. 1 has a front section 2, a boarding section 3, and a rear section 4.

The front section 2 protrudes forward from the boarding section 3. Power units, such as an engine and an electric motor, are disposed in the front section 2. The upper surface of the front section 2 is provided with an openable-closable hood 5. A hood latch 9 is provided at the front edge of the hood 5. By locking the hood latch 9, the front edge of the hood 5 is closed in an unlockable manner. Furthermore, a nose cone 6 including a bumper is provided in front of the hood 5. The upper surface of the front section 2 is constituted of the hood 5 and the upper surface of the nose cone 6.

Seats on which on-board occupants sit are provided in the boarding section 3. The front surface of the boarding section 3 is provided with a front windshield 7 at a position above the upper surface of the front section 2.

The rear section 4 protrudes rearward from the boarding section 3. A luggage space is provided in the rear section 4.

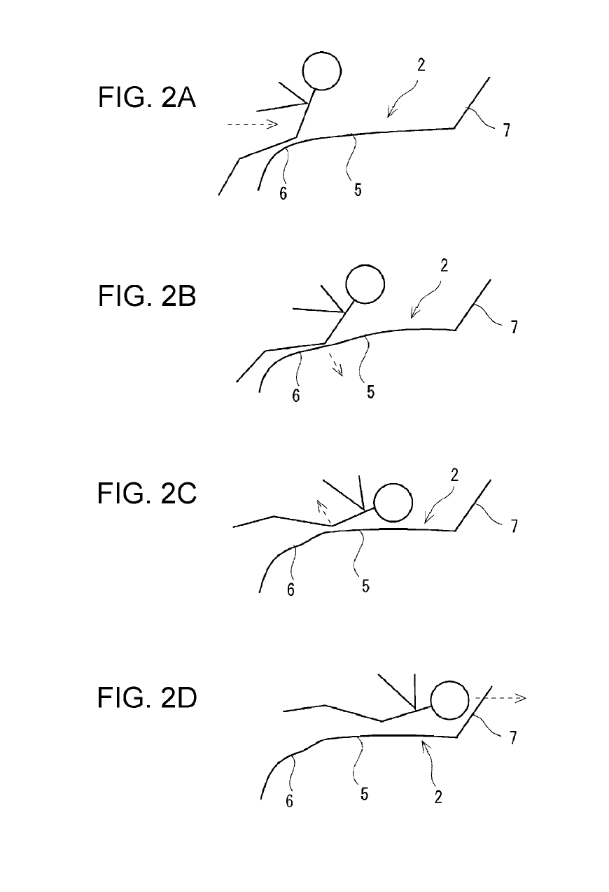

FIGS. 2A to 2D illustrate an example of a vehicle-to-cyclist collision mode.

When a cyclist collides with the front of the automobile 1, the cyclist falls up onto the hood 5 of the automobile 1 after the collision, as illustrated in FIG. 2A, due to the position of the cyclist's waist being high.

Then, the hood 5 is dented and deformed due to the load from the fallen cyclist, as illustrated in FIG. 2B. Subsequently, the hood 5 pushes the cyclist upward, as illustrated in FIG. 2C.

For example, the cyclist pushed upward by the hood 5 in this manner moves rearward, as illustrated in FIG. 2D, in accordance with the relative speed and the relative moving direction of the automobile 1 and the cyclist. In this case, the cyclist's head may possibly hit against the front windshield 7.

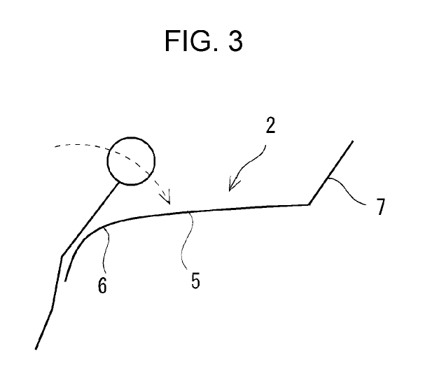

FIG. 3 illustrates an example of a vehicle-to-pedestrian collision mode.

As illustrated in FIG. 3, when a pedestrian collides with the front of the automobile 1, the upper body of the pedestrian rotates down about the position of the waist toward the hood 5 of the automobile 1. Thus, the pedestrian is unlikely to fall up onto the hood 5 after the collision. Moreover, the pedestrian is unlikely to move rearward on the hood 5.

Accordingly, the vehicle-to-pedestrian collision mode and the vehicle-to-cyclist collision mode are different from each other. Therefore, even if an airbag is deployed flat on the hood 5 for protecting a pedestrian, it is difficult to properly protect a cyclist.

In this implementation, the performance for protecting a colliding cyclist is enhanced.

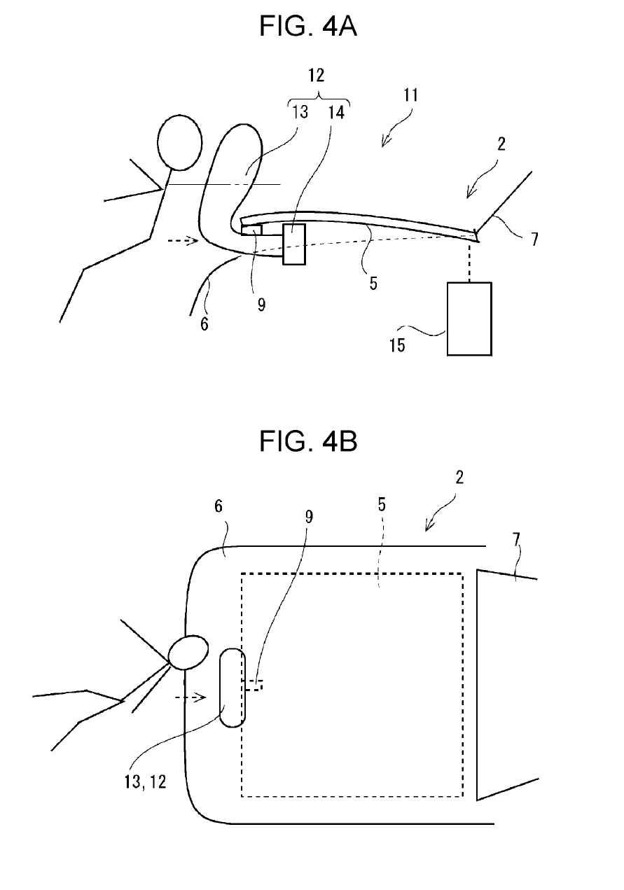

FIGS. 4A and 4B illustrate a cyclist protection apparatus 11 according to this implementation. FIG. 4A is a partial side view of the front section 2 of the automobile 1, and FIG. 4B is a top view of the front section 2 of the automobile 1.

The cyclist protection apparatus 11 in FIGS. 4A and 4B has a cyclist airbag device 12 and an actuator 15. In FIGS. 4A and 4B, the hood latch 9 is unlocked so that the front edge of the hood 5 is in an openable-closable state.

The actuator 15 is, for example, a motor. The actuator 15 drives the hood 5 so as to open the front of the hood 5.

The cyclist airbag device 12 has a cyclist airbag 13 and a main body 14 that accommodates the cyclist airbag 13 and an inflator.

The main body 14 is provided below the hood 5. The cyclist airbag 13 is deployed forward from the main body 14.

The cyclist airbag 13 deploys in a state where the front of the hood 5 is open, as illustrated in FIGS. 4A and 4B, so as to deploy forward from below the hood 5.

Furthermore, a part of the cyclist airbag 13 that protrudes from the hood 5 deploys upward. The cyclist airbag 13 deploys to a height equal to or above the height of the cyclist's shoulders indicated by a two-dot chain line in FIG. 4A. This height may be, for example, about 50 cm to 1 m.

Because the cyclist airbag 13 deploys upward in this manner, a portion of the upward deployment force of the cyclist airbag 13 may be used to lift the front edge of the hood 5 upward by the cyclist airbag 13 alone, instead of using the actuator 15.

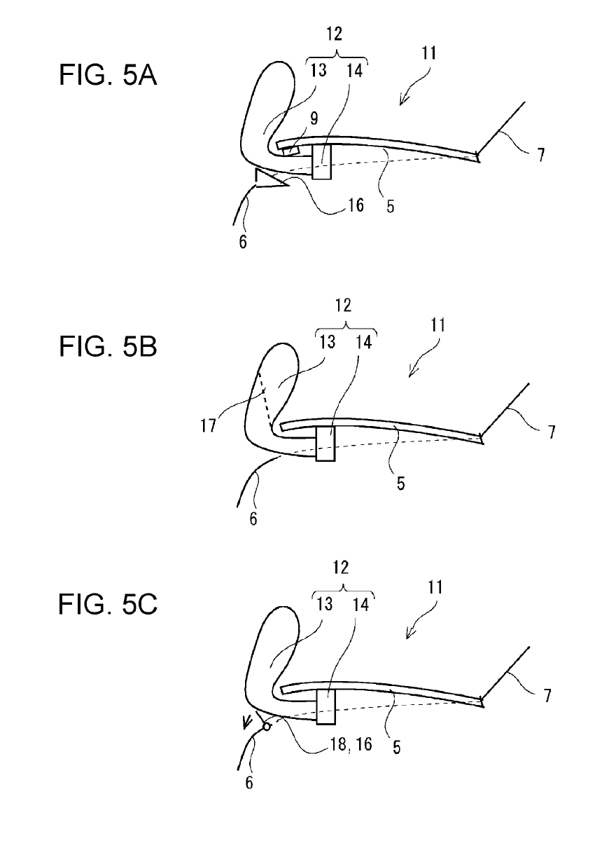

FIGS. 5A to 5C illustrate configuration examples in which the deployment direction of the cyclist airbag 13 is converted from the forward direction to the upward direction.

In FIG. 5A, the rear end of the upper surface of the nose cone 6 located in front of the hood 5 is provided with a forward-rising slope 16. Thus, the cyclist airbag 13 that has started to deploy forward from below the hood 5 abuts on the slope 16 so that the cyclist airbag 13 can deploy upward.

In FIG. 5B, the center of the upper surface of the cyclist airbag 13 and the lower surface of the leading end thereof are coupled to each other by a tether 17. Thus, the cyclist airbag 13 that has started to deploy forward from below the hood 5 is pulled upward by the tension of the tether 17 as the deployment progresses. As a result, the cyclist airbag 13 can deploy upward.

In FIG. 5C, the rear end of the upper surface of the nose cone 6 located in front of the hood 5 is provided with a movable piece 18 that is vertically rotatable. Thus, the cyclist airbag 13 that has started to deploy forward from below the hood 5 abuts on the movable piece 18 as the cyclist airbag 13 deploys forward from below the hood 5. The movable piece 18 rotates upward so as to form the forward-rising slope 16. The cyclist airbag 13 deploying further forward abuts on the slope 16 formed by the movable piece 18 so that the cyclist airbag 13 can deploy upward.

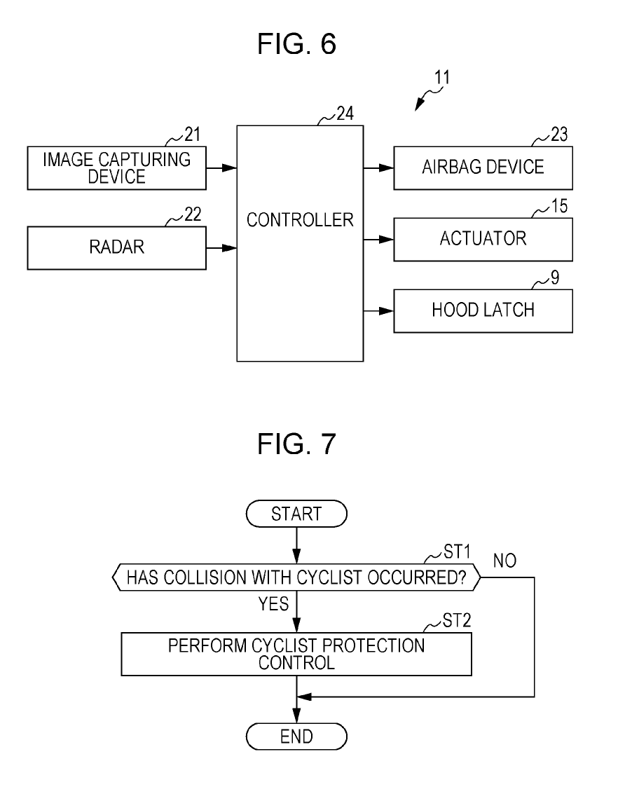

FIG. 6 is a block diagram of a control system of the cyclist protection apparatus 11 in FIGS. 4A and 4B.

In the control system in FIG. 6, an image capturing device 21, a radar 22, an airbag device 23, the actuator 15, the hood latch 9, and a controller 24 coupled to these devices are illustrated. The airbag device 23 includes the cyclist airbag device 12.

The controller 24 predicts a collision based on detections by the image capturing device 21 and the radar 22 and detects a collision. Then, the controller 24 outputs an inflator ignition signal to the airbag device 23 at a necessary timing.

For example, if a collision with a cyclist is detected, an ignition signal is output to the cyclist airbag device 12, so that the cyclist airbag 13 is deployed.

The image capturing device 21 is, for example, a pair of image capturing elements provided facing forward at either one of the roof of the boarding section 3 and the front windshield 7, as illustrated in FIG. 1, and observes the peripheral conditions ahead of the automobile 1 by imaging.

The radar 22 is disposed at, for example, the front surface of the front section 2 of the automobile 1, as illustrated in FIG. 1. The radar 22 emits an ultrasonic wave or a radio wave and observes the peripheral conditions ahead of the automobile 1 in accordance with, for example, whether or not there is a reflected wave.

Then, the controller 24 specifies an obstacle, such as a cyclist passing in front of the automobile 1, so as to determine whether there is a possibility of a collision with the obstacle.

FIG. 7 is a flowchart of control executed by the controller 24 in FIG. 6 when a collision with a cyclist occurs.

The controller 24 periodically executes the cyclist collision control in FIG. 7.

As illustrated in FIG. 7, the controller 24 determines whether or not a collision with a cyclist has occurred (step ST1). For example, if a collision with a cyclist is detected, it may be determined that the collision with the cyclist has occurred.

If the collision with the cyclist has occurred, the controller 24 executes control for protecting the cyclist (step ST2).

Specifically, the hood latch 9 is first unlocked. Thus, the closed state of the hood 5 is released so that the front edge thereof can be opened. Moreover, the actuator 15 opens the front of the hood 5, so that the front edge of the hood 5 is set in an open state.

Subsequently, an ignition signal is output to the cyclist airbag device 12.

Consequently, as illustrated in FIGS. 4A and 4B, the cyclist airbag 13 deploys forward from below the hood 5 and then deploys upward.

Alternatively, the front edge of the hood 5 may be lifted upward by the cyclist airbag 13 alone, instead of using the actuator 15.

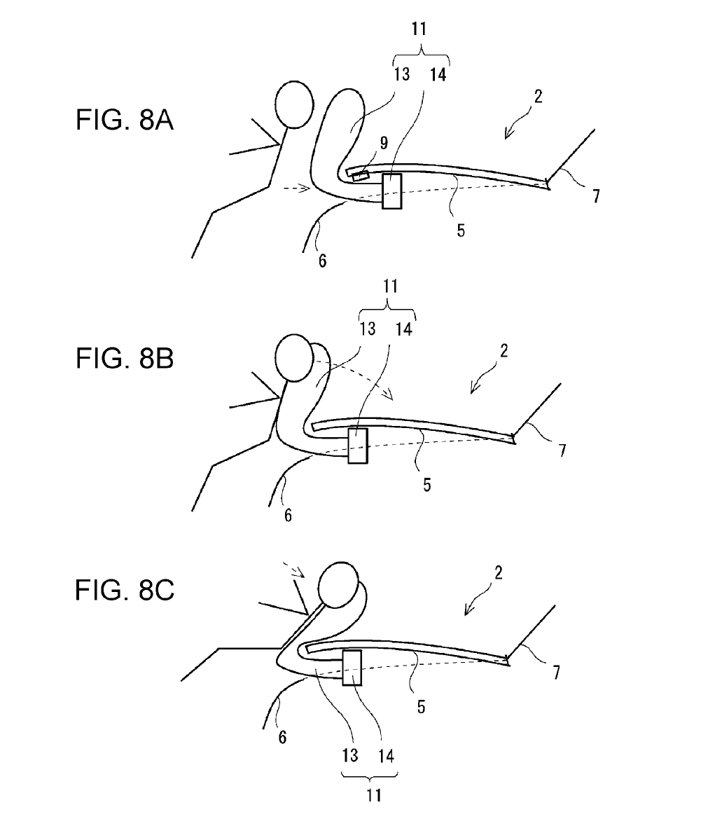

FIGS. 8A to 8C illustrate an example of a vehicle-to-cyclist collision mode according to this implementation.

By executing the control in FIG. 7, the cyclist airbag 13 deploys upward from the front of the hood 5, the front of which is open, at the upper surface of the front section 2 of the automobile 1.

Then, the colliding cyclist tends to fall up onto the hood 5 of the automobile 1, as illustrated in FIG. 8A, due to the position of the cyclist's waist being high.

In this implementation, since the cyclist airbag 13 deploys upward, the cyclist's upper body and waist come into contact with the cyclist airbag 13, so that the load of the cyclist's upper body and waist is applied thereto.

Furthermore, since the cyclist's waist is supported by the lower part of the cyclist airbag 13, the cyclist rotates downward toward the hood 5, as illustrated in FIG. 8B, due to subsequent inertia.

Then, the upper body of the cyclist falling toward the hood 5 falls up onto the cyclist airbag 13, as illustrated in FIG. 8C.

Accordingly, in this implementation, the cyclist airbag device 12 deploys the cyclist airbag 13 forward from below the hood 5 in either one of a state where the front of the hood 5 is openable or a state where the front of the hood 5 is open. Thus, even if the cyclist tends to fall up onto the front section 2 of the automobile 1 from the front side after the collision, the cyclist airbag 13 can receive the body of the cyclist. The falling cyclist is unlikely to move rearward thereafter. Consequently, the performance for protecting the colliding cyclist can be enhanced.

Furthermore, in this implementation, the cyclist airbag 13 that has started to deploy forward from below the hood 5 subsequently deploys upward. Thus, the cyclist's body that tends to fall up onto the front section 2 of the automobile 1 from the front side after the collision can be received by the cyclist airbag 13.

Furthermore, in this implementation, the cyclist airbag 13 deploys to a height equal to or above the height of the cyclist's shoulders. Consequently, the entire body of the cyclist that tends to fall up onto the front section 2 of the automobile 1 from the front side after the collision can be received by the cyclist airbag 13.

In contrast, in a case where only a part of the body is received by an airbag, displacement is likely to occur in the body between the area that has received the part of the body and the remaining area.

Furthermore, in this implementation, the rear end of the upper surface of the nose cone 6 provided in front of the hood 5 has the forward-rising slope 16. Thus, the cyclist airbag 13 that has started to deploy forward from below the hood 5 can deploy upward by abutting on the slope 16.

Furthermore, in this implementation, the cyclist airbag 13 has the tether 17 that couples the center of the upper surface to the lower surface of the leading end. Thus, the cyclist airbag 13 that has started to deploy forward from below the hood 5 can deploy upward by being pulled upward by the tension of the tether 17.

Furthermore, in this implementation, the rear end of the upper surface of the nose cone 6 provided in front of the hood 5 is provided with the movable piece 18 that is vertically rotatable. Thus, the cyclist airbag 13 that has started to deploy forward from below the hood 5 can deploy upward by abutting on the movable piece 18 as the cyclist airbag 13 deploys forward from below the hood 5.

Although the implementation described above is an example of a preferred implementation of the present invention, the present invention is not limited to the above implementation and permits various modifications and alterations so long as they do not depart from the scope of the invention.

1. A cyclist protection apparatus for a vehicle comprising a front section that protrudes forward from a boarding section and includes an upper surface formed by a hood, the cyclist protection apparatus comprising:
a hood latch capable of releasing a closed state of the hood such that a front of the hood is openable; and
a cyclist airbag device configured to be disposed in the front section below the hood and to deploy a cyclist airbag, the cyclist airbag device being configured to deploy the cyclist airbag forward from below the hood in either one of a state where the front of the hood is open and a state where the front of the hood is openable.

2. The cyclist protection apparatus for a vehicle according to claim 1, further comprising:
an actuator configured to drive the hood so as to open the front of the hood.

3. The cyclist protection apparatus for a vehicle according to claim 1,
wherein the cyclist airbag is configured to start to deploy forward from below the hood and subsequently deploy upward.

4. The cyclist protection apparatus for a vehicle according to claim 2,
wherein the cyclist airbag is configured to start to deploy forward from below the hood and subsequently deploy upward.

5. The cyclist protection apparatus for a vehicle according to claim 3,
wherein the cyclist airbag is configured to deploy to a height equal to or above a height of a cyclist's shoulder.

6. The cyclist protection apparatus for a vehicle according to claim 4,
wherein the cyclist airbag is configured to deploy to a height equal to or above a height of a cyclist's shoulder.

7. The cyclist protection apparatus for a vehicle according to claim 3, further comprising:
a nose cone to be provided in front of the hood in the front section,
wherein a rear-end area of an upper surface of the nose cone has a forward-rising slope, and
wherein the cyclist airbag, which has started to deploy forward from below the hood, deploys upward by abutting on the slope.

8. The cyclist protection apparatus for a vehicle according to claim 4, further comprising:
a nose cone to be provided in front of the hood in the front section,
wherein a rear-end area of an upper surface of the nose cone has a forward-rising slope, and
wherein the cyclist airbag, which has started to deploy forward from below the hood, deploys upward by abutting on the slope.

9. The cyclist protection apparatus for a vehicle according to claim 5, further comprising:
a nose cone to be provided in front of the hood in the front section,
wherein a rear-end area of an upper surface of the nose cone has a forward-rising slope, and
wherein the cyclist airbag, which has started to deploy forward from below the hood, deploys upward by abutting on the slope.

10. The cyclist protection apparatus for a vehicle according to claim 6, further comprising:
a nose cone to be provided in front of the hood in the front section,
wherein a rear-end area of an upper surface of the nose cone has a forward-rising slope, and
wherein the cyclist airbag, which has started to deploy forward from below the hood, deploys upward by abutting on the slope.

11. The cyclist protection apparatus for a vehicle according to claim 3,
wherein the cyclist airbag comprises a tether that couples a center of an upper surface to a lower surface of a leading end of the cyclist airbag, and
wherein the cyclist airbag is configured to start to deploy forward from below the hood and subsequently deploy upward by being pulled upward by tension of the tether.

12. The cyclist protection apparatus for a vehicle according to claim 4,
wherein the cyclist airbag comprises a tether that couples a center of an upper surface to a lower surface of a leading end of the cyclist airbag, and
wherein the cyclist airbag is configured to start to deploy forward from below the hood and subsequently deploy upward by being pulled upward by tension of the tether.

13. The cyclist protection apparatus for a vehicle according to claim 5,
wherein the cyclist airbag comprises a tether that couples a center of an upper surface to a lower surface of a leading end of the cyclist airbag, and
wherein the cyclist airbag is configured to start to deploy forward from below the hood and subsequently deploy upward by being pulled upward by tension of the tether.

14. The cyclist protection apparatus for a vehicle according to claim 6,
wherein the cyclist airbag comprises a tether that couples a center of an upper surface to a lower surface of a leading end of the cyclist airbag, and
wherein the cyclist airbag is configured to start to deploy forward from below the hood and subsequently deploy upward by being pulled upward by tension of the tether.

15. The cyclist protection apparatus for a vehicle according to claim 3, further comprising:
a nose cone to be provided in front of the hood in the front section,
wherein a rear-end area of an upper surface of the nose cone is provided with a movable piece that is vertically rotatable, and
wherein the cyclist airbag, which has started to deploy forward from below the hood, deploys upward by abutting on the movable piece as the cyclist airbag deploys forward from below the hood.

16. The cyclist protection apparatus for a vehicle according to claim 4, further comprising:
a nose cone to be provided in front of the hood in the front section,
wherein a rear-end area of an upper surface of the nose cone is provided with a movable piece that is vertically rotatable, and
wherein the cyclist airbag, which has started to deploy forward from below the hood, deploys upward by abutting on the movable piece as the cyclist airbag deploys forward from below the hood.

17. A vehicle comprising:
a hood;
a front section that protrudes forward from a boarding section, the front section comprising an upper surface formed by the hood;
a hood latch capable of releasing a closed state of the hood such that a front of the hood is openable; and
a cyclist airbag device disposed in the front section below the hood and configured to deploy a cyclist airbag, the cyclist airbag device being configured to deploy the cyclist airbag forward from below the hood in either one of a state where the front of the hood is open and a state where the front of the hood is openable.
